(19) United States
(12) Patent Application Publication
(10) Pub. No.: US 2003/0087097 A1
(43) Pub. Date: May 8, 2003

(54) Force-transmitting surface layer and process for its production

(76) Inventors: Jorg Lukschandel, Kempten (DE); Jurgen Meyer, Kempten (DE); Wolfgang Haggenmuller, Kempten (DE)

Correspondence Address: COLLARD & ROE, P.C., 1077 Northern Boulevard, Roslyn, NY, 11576-1696, US

(21) Appl. No.: 10/256,640

(22) Filed: Sep. 27, 2002

(30) Foreign Application Priority Data
Oct. 4, 2001 (DE) 10148 831.9

(51) Int. Cl. B05D 3/02; B05D 1/36; B32B 9/00

(52) U.S. Cl. 428/408; 427/404; 427/383.1; 428/323

(57) ABSTRACT

A component surface is coated with friction-increasing particles in a matrix, wherein the matrix comprises an upper layer and a lower layer, the lower layer being a metallic binder phase which is customary for friction-increasing fixing and the upper layer being a further metallic binder phase with a thickness of from 40 to 60% of the mean diameter of the particles.

### BACKGROUND OF THE INVENTION

1. Field of the Invention The invention relates to a force-transmitting surface layer and to a process for producing it.

2. The Prior Art

Force-fitting connections are often used to transmit forces between the individual components of a structure. In these connections, the adhesion forces prevailing between the joined component surfaces determine the level of transverse forces which can be transmitted. What is known as the friction coefficient μ determines what proportion of the normal force present can still be introduced as transverse force into the connection before slipping occurs. For a dry connection of steel surfaces, the friction coefficient μ is approximately 0.15.

A higher friction coefficient makes it possible to increase the load-bearing capacity of existing structures or, for the same function, to select a more lightweight design. In accordance with these requirements, there have been numerous proposals aimed at increasing the adhesion between component surfaces which are to be joined. If these are nonreleasable connections which remain in the joined state throughout the entire service life of the structure, the introduction of foreign substances, such as adhesives, solders or the like, into the joint gap is a tried-and-tested technique.

Releasable connections, in particular screw connections, clamping devices, parking brakes or the like, do not allow the use of auxiliaries of this type. In these cases, it is often attempted to introduce hard particles into the joint gap, leading to a positively-locking connection on the micro scale by partially penetrating into the component surfaces. The application of metal layers studded with particles to one of the joining surfaces using coating techniques has proven particularly effective and reproducible. Friction-increasing layers of this type are described, for example, in Leidlich et al., Antriebstechnik [drive engineering] 38, No. 4. European Patent No. EP 961 038 A 1 describes a connecting element which is coated on both surfaces and is used where direct coating of the component surface is not possible. These friction-increasing layers are produced in metallization baths with solid particles dispersed therein. The continuous incorporation of particles in the growing layer is inherent to this process, and this leads to the particles which are incorporated at the end of the coating process only being surrounded by a small part of the layer matrix, so that they are not securely anchored therein.

When components which have been coated in this manner are handled further, insufficiently anchored particles may become detached. This is unacceptable when used, for example, in motor construction if the location of installation is in the oil chamber: detached particles of hard material, in particular the diamond grains which are generally used for force-transmitting coatings, would be conveyed with the oil into bearings, where they would lead to premature wear. To solve this problem, it is in principle conceivable for the inadequately anchored particles to be deliberately removed by machining before final assembly. However, in practice this procedure has proven unfavorable or even harmful to the functionality of the surface which then remains, since the latter is contaminated or smeared by inevitable abrasion from the machine tools, which in turn impairs the actual force-transmission function of a coated surface which has been treated in this manner.

### SUMMARY OF THE INVENTION

Therefore, it is an object of the invention to provide a component surface which is coated with friction-increasing particles in a matrix and which does not have the abovementioned problems.

The object is achieved by a matrix that comprises an upper layer and a lower layer, the lower layer being a metallic binder phase which is customary for friction-increasing fixing and the upper layer being a further metallic binder phase with a thickness of from 40 to 60% of the mean diameter of the particles. The matrix preferably comprises these two layers.

The particles are preferably particles which are customary for friction-increasing coatings, as are known, for example, from EP-A-0961038, p. 3, lines 10 to 20. Most preferably, they are diamond grains. The particles preferably have a mean diameter of 5 μm to 35 μm, most preferably of 10 μm to 25 μm.

The lower layer is preferably a metallic binder phase which is customary for friction-increasing coatings and is known from the documents cited above. It is particularly preferably a metallic binder phase comprising chemical nickel. The lower layer preferably has a thickness of 5 to 15 μm. The upper layer preferably consists of chemical nickel. The upper layer preferably has a thickness of 5 to 15 μm. The thickness of the upper layer is preferably half the particle diameter.

The two-layer structure of the matrix anchors the hard-material particles in the matrix in such a manner that there is no possibility of the particles becoming detached. Reliable anchoring of the hard-material particles in the layer matrix is achieved by applying an additional metal layer which does not contain any particles used to transmit forces. Since the particles are held in place by purely mechanical means and there are no adhesion or other bonding forces, the particles which are to be secured have to be surrounded by matrix material at least as far as their equator. Therefore, the layer which is to be additionally applied is selected to have a thickness of no more than half the diameter of the force-transmitting particles projects out of the new matrix surface.

The surface according to the invention is produced as follows: a surface which has been provided with a friction-increasing particle-containing coating by means of a process which is customary in the prior art is provided with an additional coating of chemical nickel. This additional coating is preferably likewise applied by means of a process which is known from the prior art. This bath is preferably completely free of solid particles. In some cases, however, it may also be expedient for significantly finer particles, preferably with a grain size of 1 to 4 μm, to be dispersed therein in order to have a controlled influence on the strength properties of the second layer. The surface which is to be coated may be the surface of a component; however, it may also be the surface of a resilient sheet.

To increase the strength of the matrix, finally a heat treatment is carried out. The heat treatment preferably takes place in a temperature range from 150 to 400° C. for a period of 1 to 5 hours. At temperatures of over 330° C., in the case of chemical nickel layers, a precipitation of Ni₃P crystals takes place, leading to internal compressive stresses and an increase in hardness. These internal compressive stresses in the matrix are desirable, since the incorporated particles are held more securely as a result.

However, internal compressive stresses are also formed to a certain extent even without a heat treatment as a result of dispersion of fine solid particles in the layer so that, if the base material of the component which is to be coated is sensitive to tempering, the desired consolidation effect can also be achieved at a lower hardening temperature if the upper layer is formed as a dispersion layer which includes fine particles. These fine particles themselves do not participate in the force-transmission operation.

### BRIEF DESCRIPTION OF THE DRAWINGS

Other objects and features of the present invention will become apparent from the following detailed description considered in connection with the accompanying drawing. It is to be understood, however, that the drawing is designed as an illustration only and not as a definition of the limits of the invention.

FIG. 1 diagrammatically depicts the structure of a coating according to the invention.

### DETAILED DESCRIPTION OF THE PREFERRED EMBODIMENT

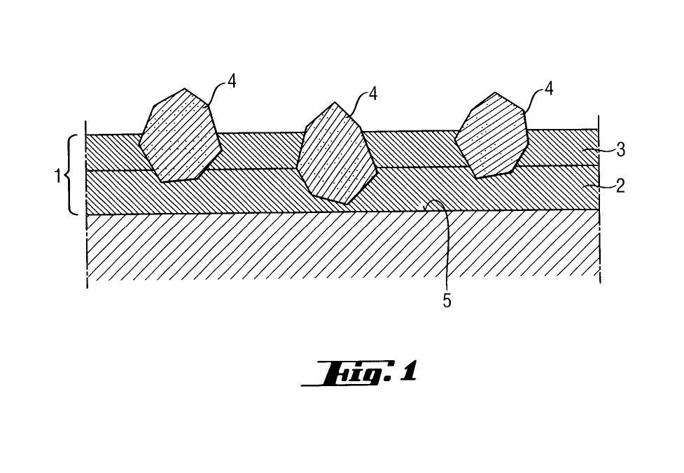

FIG. 1 shows the coating 1 according to the invention. Surface 5 is coated with a lower layer 2 and an upper layer 3. Lower layer 2 is a metallic binder phase which is customary for friction-increasing fixing. Upper layer 3 is a further metallic binder phase with a thickness of from 40 to 60% of the mean diameter of the particles 4.

Particles 4 are preferably particles which are customary for friction-increasing coatings and are preferably, diamond grains. Particles 4 preferably have a mean diameter of 5 μm to 35 μm, most preferably of 10 μm to 25 μm. Lower layer 2 is preferably a metallic binder phase which is customary for friction-increasing coatings and is known from the documents cited above. It is particularly preferably a metallic binder phase comprising chemical nickel. Lower layer 2 preferably has a thickness of 5 to 15 μm.

Upper layer 3 has a thickness which is no more than half the diameter of the force-transmitting particles 4 projecting out of the new matrix surface.

The following example serves to further explain the invention.

### EXAMPLE

To improve the shrink-fit of a gear wheel onto a shaft journal, the hole in the gear wheel is provided with a friction-increasing coating. The shaft journal has a roughness Rz=8 μm. The coating specified is chemical nickel with incorporated diamond particles of a grain size of 10 μm.

When the shrink-fit connection used in the oil chamber of an engine is being joined, no diamond particles should become detached, since they cannot reliably be trapped by the oil filter.

To apply the coating, the procedure is as follows: The toothed region of the gear wheel is protected from contact with treatment chemicals by being covered using the methods which are customarily used in electrochemistry. The gear wheel is secured to a rotating support and is suspended in the conveyer system of an electro deposition installation using this support. After it has passed through the material-specific pretreatment (degreasing, pickling and activation) which is known to the person skilled in the art of electro deposition, the component is immersed in the actual coating bath. This bath is a nickel hypophosphite bath which operates without external current (“chemically”) and in which diamond particles with a grain size of 10 μm are dispersed. Bath movement by stirring, pump circulation or by blowing in air prevents the diamond particles from sedimenting out.

During the coating operation, the component which is to be coated rotates, in order to allow uniform, random deposition of the diamond particles on the entire surface which is to be coated (in this case the bore). The nickel layer is deposited in an unoriented manner on all the exposed component surfaces. The interplay between random deposition of the particles on surfaces which periodically face upward and constant growth of the nickel layer results in the formation of a metal layer which is studded with particles. This operation continues throughout the entire immersion time, so that there are always particles which have only just been taken hold of by the growing metal layer but are only weakly anchored therein.

The component which has been coated in this way is removed from the bath and first of all particles resting loosely on it are removed, together with the carrier, by means of ultrasound.

Then, the surface of the first nickel matrix of the component is chemically activated again, and the component is immersed in a second coating bath, which preferably has the same chemical composition as the bath used to produce the first layer, but no longer contains any diamond particles with a grain size 10 μm.

The immersion time in this second bath is such that a covering layer of 0.5×the diameter of the incorporated 10 μm diamond grains, i.e. with a thickness of 5 μm, grows onto the original layer matrix. This can be achieved with accuracy since the deposition rates of chemical nickel baths are known and are easy to control.

After the component has been removed from the second coating bath, all the diamond particles with a grain size of 10 μm which were previously at the surface have been surrounded by the metal matrix at least up to their equator.

Finally, to increase the strength of the matrix, a heat treatment is carried out at 350° C. for a period of 120 min.

Accordingly, while only a single embodiment of the present invention have been shown and described, it is obvious that many changes and modifications may be made thereunto without departing from the spirit and scope of the invention.

What is claimed is:

1. A component surface coated with friction-increasing particles in a matrix, said matrix comprising an upper layer and a lower layer, the lower layer being a metallic binder phase for friction-increasing fixing and the upper layer being a further metallic binder phase with a thickness of from 40 to 60% of a mean diameter of the particles.

2. The component surface as claimed in claim 1, wherein the friction-increasing particles are diamond grains.

3. The component surface as claimed in claim 1, wherein the particles have a mean diameter of 5 μm to 35 μm.

4. The component surface as claimed in claim 1, wherein the lower layer is a metallic binder phase comprising chemical nickel.

5. The component surface as claimed in claim 1, wherein the lower layer has a thickness of 5 to 15 μm.

6. The component surface as claimed in claim 1, wherein the upper layer comprises chemical nickel.

7. The component surface as claimed in claim 1, wherein the upper layer has a thickness corresponding to half the mean particle diameter.

8. A process for producing a component surface coated with friction-increasing particles in a matrix, said matrix comprising an upper layer and a lower layer, said process comprising:
providing a friction-increasing particle-containing coating on said surface; and
providing said coated surface with an additional coating of chemical nickel.

9. The process as claimed in claim 8, further comprising heat treating the surface in a temperature range from 150 to 400° C. for a period of 1 to 5 hours after the additional coating of chemical nickel is applied.
